(19) United States
(12) Patent Application Publication
(10) Pub. No.: US 2025/0039833 A1
(43) Pub. Date: Jan. 30, 2025

(54) WIRELESS DEVICE, CONTROL METHOD, AND STORAGE MEDIUM

(71) Applicant: BUFFALO INC., Nagoya-shi (JP)

(72) Inventors: Hirotaka NARUSE, Aichi (JP); Jun MARUYAMA, Aichi (JP)

(73) Assignee: BUFFALO INC., Nagoya-shi (JP)

(21) Appl. No.: 18/780,688

(22) Filed: Jul. 23, 2024

(30) Foreign Application Priority Data
Jul. 26, 2023 (JP) 2023-121481

(51) Int. Cl. H04W 64/00; H04W 76/10; H04W 92/10

(52) U.S. Cl. CPC H04W 64/00; H04W 76/10; H04W 92/10

(57) ABSTRACT

A wireless device includes a wireless communication interface configured to perform wireless communication on a first communication channel which is available under a condition that the wireless device transmits position information to a server, and wireless communication on a second communication channel different from the first communication channel. The wireless device also includes a control circuit configured to perform, under a condition that the wireless device is not able to acquire position information of the wireless device, allowing the wireless communication interface to start the wireless communication on the second communication channel with a communication terminal, receiving position information of the communication terminal from the communication terminal, and transmitting the position information of the communication terminal to the server to make available the wireless communication on the first communication channel.

### CROSS-REFERENCE TO RELATED APPLICATION

This application is based on and claims priority under 35 USC 119 from Japanese Patent Application No. 2023-121481 filed on Jul. 26, 2023, the contents of which are incorporated herein by reference.

### TECHNICAL FIELD

The present disclosure relates to a wireless device, a control method, and a storage medium.

### BACKGROUND

In recent years, in advancing a wireless local area network (LAN), an unlicensed 6 GHz band has been studied. For example, in the 6 GHz band of Japan, only the UNII-5 channel can be freely used in Wi-Fi 6E (registered trademark). In order to improve the convenience of the 6 GHz band, it is preferable to freely use UNII-6 to UNII-8 channels in Wi-Fi 7 (registered trademark). However, in order to use UNII-6 to UNII-8 channels at present, there is a possibility that a permission for use is required in which an access point of a wireless LAN acquires setting information from an automated frequency coordination (AFC) system. In order to acquire the setting information from the AFC system, it is necessary to transmit position information of the access point to the AFC system.

Japanese Unexamined Patent Application Publication No. 2020-057907 (hereinafter referred to as Patent Literature 1) discloses a method of causing a wireless slave device belonging to a wireless access point to return current position information of the wireless slave device, and acquiring the returned current position information of the wireless slave device as current position information of the wireless access point.

However, for example, during communication in UNII-6 to UNII-8, in a case where the wireless access point cannot normally receive a global positioning system (GPS) signal in an abnormal radio wave environment such as indoors, the setting information cannot be obtained from the AFC system, and the communication on UNII-6 to UNII-8 cannot be performed.

Moreover, in Patent Literature 1, in a case where a communication channel that requires a permission for use is used, it is not assumed that use of the communication channel is not permitted due to a radio wave environment in which the wireless access point cannot acquire the GPS signal (position information) or the like. In addition, when an AFC update time passes before the GPS signal (position information) is acquired, the communication on UNII-6 to UNII-8 is stopped (communication disconnection).

The present disclosure provides a wireless device, a control method, and a storage medium that are capable of performing wireless communication on a communication channel available by transmitting position information while preventing communication disconnection.

### SUMMARY

A first aspect of the present disclosure relates to a wireless device including: a wireless communication interface configured to perform wireless communication on a first communication channel which is available under a condition that the wireless device transmits position information to a server, and wireless communication on a second communication channel different from the first communication channel; and a control circuit configured to perform processing under a condition that the wireless device is not able to acquire position information of the wireless device. The processing includes: allowing the wireless communication interface to start the wireless communication on the second communication channel with a communication terminal; receiving position information of the communication terminal from the communication terminal; and transmitting the position information of the communication terminal that is received to the server to make available the wireless communication on the first communication channel.

A second aspect of the present disclosure relates to a control method for a wireless device having a wireless communication interface, to be performed by a processor of the wireless device. The method includes: controlling the wireless communication interface to perform wireless communication on a first communication channel which is available under a condition that the wireless device transmits position information to a server, and wireless communication on a second communication channel different from the first communication channel; and under a condition that the wireless device is not able to acquire position information of the wireless device, allowing the wireless communication interface to start the wireless communication on the second communication channel with a communication terminal; receiving, from the communication terminal, position information of the communication terminal; and transmitting the position information of the communication terminal that is received to the server to make available the wireless communication on the first communication channel.

A third aspect of the present disclosure relates to a non-transitory computer-readable storage medium that stores a control program for causing a computer of a wireless device having a wireless communication interface to execute a process. The process includes: controlling the wireless communication interface to perform wireless communication on a first communication channel which is available under a condition that the wireless device transmits position information to a server, and wireless communication on a second communication channel different from the first communication channel, and under a condition that the wireless device is not able to acquire position information of the wireless device, allowing the wireless communication interface to start the wireless communication on the second communication channel with a communication terminal; receiving, from the communication terminal, position information of the communication terminal; and transmitting the position information of the communication terminal that is received to the server to make available the wireless communication on the first communication channel.

### BRIEF DESCRIPTION OF DRAWINGS

Exemplary embodiment of the present disclosure will be described in detail based on the following figures, wherein:

FIG. 1 shows an example of a wireless system to which a wireless device of the present disclosure is applied;

FIG. 2 shows an example of a configuration of a wireless LAN router 10;

FIG. 3 is a flowchart showing processing performed by a processor 11 of the wireless LAN router 10 according to a first embodiment;

FIG. 4 is a sequence diagram showing operations of an AFC system 30, the wireless LAN router 10, and a communication terminal 25 in a wireless system 1 according to the first embodiment;

FIG. 5 is a flowchart showing processing performed by the processor 11 of the wireless LAN router 10 according to a second embodiment;

FIG. 6 is a sequence diagram showing operations of the AFC system 30, the wireless LAN router 10, and the communication terminal 25 in the wireless system 1 according to the second embodiment;

FIG. 7 is a flowchart showing a modification of the processing according to the second embodiment described in FIG. 5; and

FIG. 8 is a sequence diagram showing a modification of the operations according to the second embodiment described in FIG. 6.

### DESCRIPTION OF EMBODIMENTS

Hereinafter, embodiments of the present disclosure will be described with reference to the drawings.

Wireless System to which Wireless Device of Present Disclosure is Applied

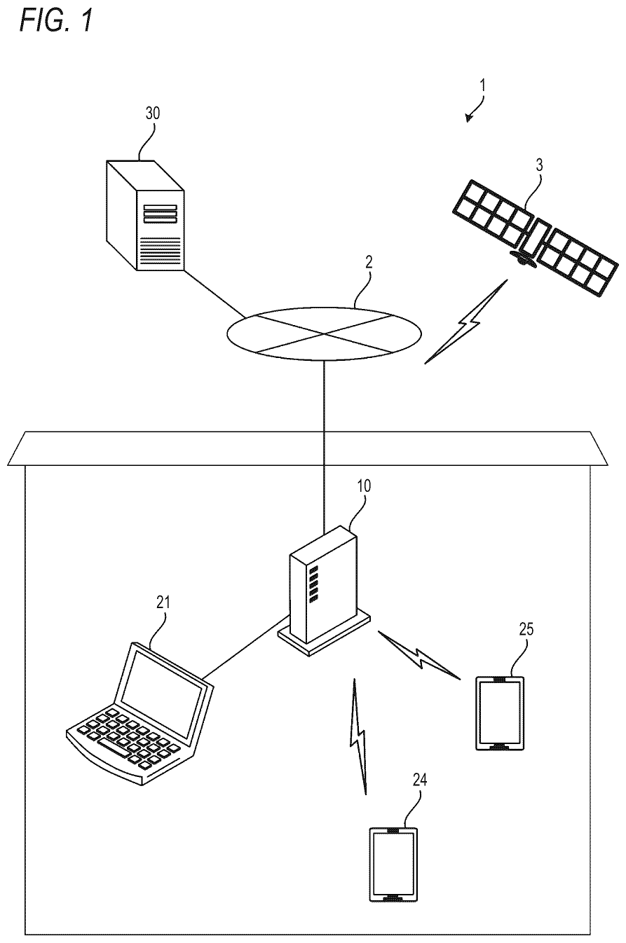

FIG. 1 shows an example of a wireless system to which a wireless device of the present disclosure is applied. A wireless system 1 shown in FIG. 1 includes, for example, a wireless LAN router 10, communication terminals 21, 24, and 25, and an AFC system 30.

The wireless LAN router 10 is an example of the “wireless device” of the present disclosure. The wireless LAN router 10 has a router function of relaying communication between information terminals (for example, communication terminals 21, 24, and 25) connected to the wireless LAN router 10 and a network 2. The network 2 is, for example, a wide area network (WAN) such as the Internet, and is connectable after connection methods are detected. The wireless LAN router 10 has a function as a wireless LAN access point. The wireless LAN router 10 may have a function of a switching hub or the like.

The wireless LAN router 10 is a router capable of wireless communication in Wi-Fi 7, Wi-Fi 6E, or the like. In Wi-Fi 7, for example, wireless communication using UNII-6 to UNII-8 channels is possible. In Wi-Fi 6E, for example, wireless communication using a UNII-5 channel is possible. The UNII-6 to UNII-8 channels are an example of a “first communication channel” of the present disclosure. The UNII-5 channel is an example of a “second communication channel” of the present disclosure.

The communication terminals 21, 24, and 25 are information terminals capable of performing wired communication or wireless communication with the wireless LAN router 10 by being communicably connected to a wireless LAN formed by the wireless LAN router 10. In the example shown in FIG. 1, the communication terminal 21 is a laptop computer that is connected to the wireless LAN router 10 by wire. The communication terminals 24 and 25 are smartphones wirelessly connected to the wireless LAN router 10. The communication terminals 24 and 25 are terminals that support wireless communication of the wireless LAN such as Wi-Fi 7 and Wi-Fi 6E.

The AFC system 30 is an example of a “server” of the present disclosure. The AFC system 30 is connectable to the network 2. The AFC system 30 is a system that requires access to obtain a permission for use when the wireless LAN router 10 uses the UNII-6 to UNII-8 channels. When information such as an identification (ID) of the wireless LAN router 10, position information based on GPS, position uncertainty information, and an installation position/direction (antenna directivity) is transmitted from the wireless LAN router 10, the AFC system 30 allocates (permits to use) a usage frequency, a use channel, a wireless output, and the like to the wireless LAN router 10. This makes it possible to avoid mutual interference when a plurality of wireless facilities use the UNII-6 to UNII-8 channels. Each of the UNII-6 to UNII-8 channels is an example of a communication channel that can be used by transmitting position information to the AFC system 30. In contrast, the UNII-5 channel is a communication channel that can be used without transmitting position information to the AFC system 30. The AFC system 30 may be a physical server or a virtual server on the cloud.

A global navigation satellite system (GNSS) satellite 3 is an artificial satellite of a satellite positioning system such as a GPS satellite. Each of the wireless LAN router 10 and the communication terminals 21, 24, and 25 includes a GNSS unit that receives a GNSS signal (for example, a GPS signal) from the GNSS satellite 3 to acquire position information of each device itself. However, there may be a situation where the wireless LAN router 10 cannot normally receive the GNSS signal from the GNSS satellite 3, for example, when the wireless LAN router 10 is provided in a central portion of a building, in particular.

### Configuration of Wireless LAN Router 10

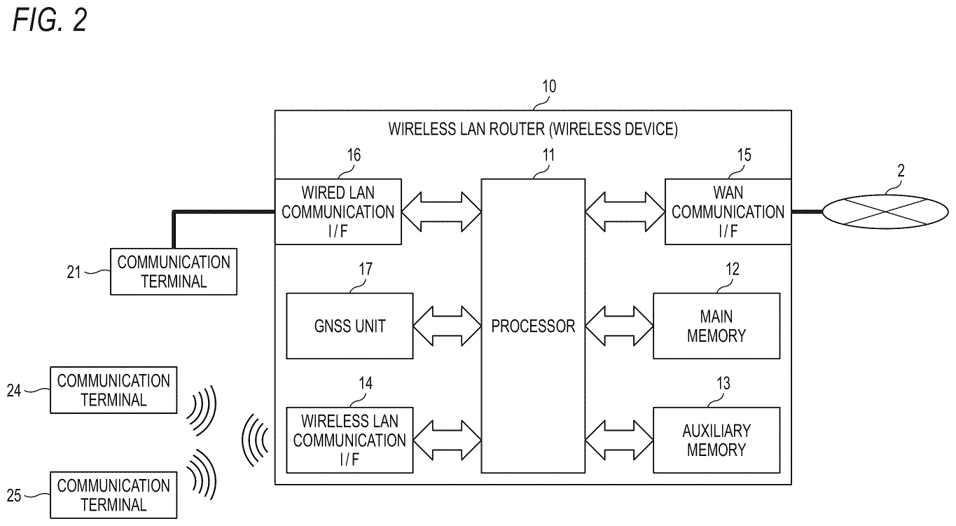

FIG. 2 shows an example of a configuration of the wireless LAN router 10. The wireless LAN router 10 includes a processor 11, a main memory 12, an auxiliary memory 13, a wireless LAN communication I/F 14, a WAN communication I/F 15, a wired LAN communication I/F 16, and a GNSS unit 17.

The processor 11 is a circuit that performs signal processing, and is, for example, a central processing unit (CPU) that controls the entire wireless LAN router 10. The processor 11 may be implemented by another digital circuit such as a field programmable gate array (FPGA) and a digital signal processor (DSP). The processor 11 may be implemented by combining a plurality of digital circuits. The processor 11 is an example of a “control circuit” of the present disclosure.

The main memory 12 is, for example, a random access memory (RAM). The main memory 12 is used as a work area of the processor 11. The auxiliary memory 13 is a nonvolatile memory such as a magnetic disk, an optical disk, or a flash memory. The auxiliary memory 13 stores various programs for operating the wireless LAN router 10. The programs stored in the auxiliary memory 13 are loaded into the main memory 12 and executed by the processor 11.

The wireless LAN communication I/F 14 is a communication interface that is connected to a LAN and performs wireless communication with wireless communication terminals (for example, the communication terminals 24 and 25) via the LAN. The wireless LAN communication I/F 14 can perform wireless communication using a 2.4 GHz band (a frequency band), a 5 GHz band, and a 6 GHz band. The WAN communication I/F 15 is a communication interface that is connected to a WAN such as the Internet and communicates with a communication device (for example, the AFC system 30) via the WAN. The wired LAN communication I/F 16 is a communication interface that is connected to a LAN and communicates with a communication terminal (for example, the communication terminal 21) via the LAN. The processor 11 and the wireless LAN communication I/F 14 are examples of a “wireless communication interface” of the present disclosure.

For example, the wireless LAN router 10 communicates with the communication terminals 24 and 25 on the LAN side through the wireless LAN communication I/F 14 and communicates with a communication device on the WAN side through the WAN communication I/F 15, thereby relaying data communication between the communication terminals 24 and 25 and the communication device on the WAN side. The wireless LAN router 10 is also capable of simultaneous connection (for example, multi-link operation (MLO)) with the wireless communication terminals (for example, the communication terminals 24 and 25) through a plurality of bands using the wireless LAN communication I/F 14. The communication terminals 24 and 25 may perform wireless communication using the 2.4 GHz band, the 5 GHz band, and the 6 GHz band. The wireless LAN router 10 communicates with the communication terminal 21 on the LAN side through the wired LAN communication I/F 16 and communicates with the communication device on the WAN side through the WAN communication I/F 15, thereby relaying data communication between the communication terminal 21 on the LAN side and the communication device on the WAN side.

The GNSS unit 17 is a unit for acquiring position information of the wireless LAN router 10. The GNSS unit 17 is a unit (for example, a GPS unit) capable of receiving radio waves from the GNSS satellite 3 (for example, a GPS satellite). The GNSS unit 17 is an example of a “position acquisition circuit”.

In the wireless LAN router 10 having such a configuration, for example, in a case where the position information of the wireless LAN router 10 cannot be acquired by the GNSS unit 17, the processor 11 starts wireless communication on the UNII-5 channel through the wireless LAN communication I/F 14 and receives position information of the communication terminals 24 and 25 from the communication terminals 24 and 25 communicably connected to the wireless LAN router 10. The processor 11 transmits the position information received from the communication terminals 24 and 25 to the AFC system 30.

The case where the position information of the wireless LAN router 10 cannot be acquired includes a case where the wireless LAN router 10 does not include the GNSS unit 17 (a GPS unit), in addition to a case where the position information of the wireless LAN router 10 cannot be acquired via the GNSS unit 17 due to a poor radio wave environment around the wireless LAN router 10. The case where the position information of the communication terminals 24 and 25 is received from the communication terminals 24 and 25 includes a case where the position information is received from the communication terminals 24 and 25 by wireless communication using, for example, UNII-6 to UNII-8 channels before the wireless communication using the UNII-5 channel is started, in addition to a case where the position information is received from the communication terminals 24 and 25 by wireless communication using the UNII-5 channel started by the wireless LAN communication I/F 14. The position information received from the communication terminals 24 and 25 is current position information of the communication terminals 24 and 25 at the time of acquisition, which is acquired by GNSS units mounted on the communication terminals 24 and 25 themselves. The communication terminal communicably connected to the wireless LAN router 10 may be, for example, a terminal (a smartphone or the like) wirelessly connected to the wireless LAN router 10 or a terminal (a notebook PC or the like) connected to the wireless LAN router 10 by wire.

After starting the wireless communication on the UNII-5 channel by the wireless LAN communication I/F 14, the processor 11 performs reacquisition processing of the position information of the wireless LAN router 10 by the GNSS unit 17. When the position information of the wireless LAN router 10 cannot be acquired by the reacquisition processing, the processor 11 receives the position information of the communication terminals 24 and 25 from the communication terminals 24 and 25, and transmits the received position information to the AFC system 30.

The processor 11 selects a predetermined communication terminal from a plurality of communication terminals (for example, the communication terminals 24 and 25) communicably connected to the wireless LAN router 10 based on a radio wave intensity between the communication terminal and the wireless LAN router 10. The processor 11 receives, from the selected predetermined communication terminal, position information of the communication terminal, and transmits the received position information to the AFC system 30. The radio wave intensity between the plurality of communication terminals and the wireless LAN router 10 is represented by, for example, a received signal strength indicator (RSSI) between the plurality of communication terminals and the wireless LAN router 10. The radio wave intensity may be measured on the wireless LAN router 10 side or may be measured on the communication terminal side. Selecting a predetermined communication terminal based on the radio wave intensity means, for example, preferentially selecting a communication terminal with a higher radio wave intensity (estimated to be closer to the wireless LAN router 10). The position information may be received from the plurality of communication terminals (for example, the top two communication terminals with a high radio wave intensity).

The processor 11 selects a predetermined communication terminal from the plurality of communication terminals (for example, the communication terminals 24 and 25) communicably connected to the wireless LAN router 10 based on a distance between the communication terminal and the wireless LAN router 10. The processor 11 receives, from the selected predetermined communication terminal, position information of the communication terminal, and transmits the received position information to the AFC system 30. The distance between the communication terminal and the wireless LAN router 10 is measured based on, for example, a radio wave reception intensity between the communication terminal and the wireless LAN router 10. The distance between the communication terminal and the wireless LAN router 10 may be determined by, for example, positioning using Bluetooth (registered trademark). Selecting a predetermined communication terminal based on the distance means, for example, preferentially selecting a closer communication terminal. The position information may be received from the plurality of communication terminals (for example, the top two communication terminals that are close in distance).

The processor 11 receives position information from the plurality of communication terminals (for example, the communication terminals 24 and 25) communicably connected to the wireless LAN router 10, and selects predetermined position information from the received position information based on a time when the communication terminal acquires the position information. The processor 11 transmits the selected predetermined position information to the AFC system 30. Selecting the predetermined position information based on the acquired time means, for example, preferentially selecting position information with a newer acquisition time (most recently acquired).

The processor 11 receives position information from the plurality of communication terminals (for example, the communication terminals 24 and 25) communicably connected to the wireless LAN router 10, and calculates predetermined position information based on the received position information of the plurality of communication terminals. The processor 11 transmits the calculated predetermined position information to the AFC system 30.

Calculating the predetermined position information based on the position information of the plurality of communication terminals means, for example, calculating an average value or a median value of the position information of the plurality of communication terminals.

The processor 11 calculates the predetermined position information based on the position information received from the communication terminal (for example, the communication terminals 24 and 25) communicably connected to the wireless LAN router 10 and a position relationship between the communication terminal and the wireless LAN router 10. The processor 11 transmits the calculated predetermined position information to the AFC system 30. The position relationship between the communication terminal and the wireless LAN router 10 may be acquired by, for example, positioning using Bluetooth. The calculated predetermined position information is, for example, position information of the wireless LAN router 10 obtained by correcting the position information of the communication terminal acquired from the communication terminal by the position relationship between the communication terminal and the wireless LAN router 10.

For example, in the case where the position information of the wireless LAN router cannot be acquired by the GNSS unit 17, the processor 11 starts the wireless communication on the UNII-5 channel through the wireless LAN communication I/F 14 and receives the position information of the communication terminals 24 and 25 by the wireless communication on the UNII-5 channel from the communication terminals 24 and 25 communicably connected to the wireless LAN router 10. The processor 11 transmits the position information received from the communication terminals 24 and 25 to the AFC system 30.

Processing Performed by Processor 11 of Wireless LAN Router 10 according to First Embodiment

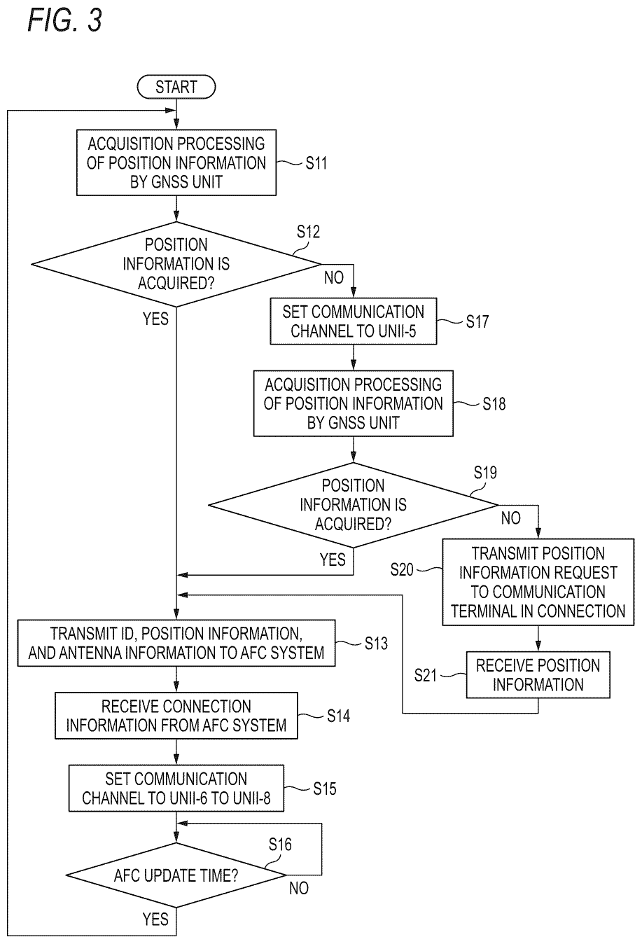

FIG. 3 is a flowchart showing processing performed by the processor 11 of the wireless LAN router 10 according to a first embodiment. The processor 11 of the wireless LAN router 10 starts the present processing when wireless communication on the UNII-6 to UNII-8 channels is performed in the wireless LAN, for example, when the wireless LAN router 10 is activated.

The processor 11 performs acquisition processing of the position information of the wireless LAN router 10 by the GNSS unit 17 (step S11). Next, the processor 11 determines whether the position information of the wireless LAN router 10 is acquired by the acquisition processing of the position information in step S11 (step S12).

If the position information is acquired in step S12 (step S12: Yes), the processor 11 transmits, for example, the ID, position information, and antenna information of the wireless LAN router 10 to the AFC system 30 (step S13).

Next, the processor 11 receives, from the AFC system 30, “connection information” which is a reply representing a permission for use of the UNII-6 to UNII-8 channels from the AFC system 30 in response to the transmission of the information in step S13 (step S14). Next, the processor 11 sets the communication channel of the wireless communication in the wireless LAN to UNII-6 to UNII-8 based on the connection information received from the AFC system 30 in step S14 (step S15).

Next, the processor 11 determines whether an AFC update time in the AFC system 30 has come (step S16). The AFC update time is a time based on a time limit permitted by the AFC system 30 for use of UNII-6 to UNII-8 channels currently performed. As the AFC update time, for example, a dynamic host configuration protocol (DHCP) lease time (for example, 23:59) may be used. Alternatively, the AFC update time may be, for example, after a certain period of time (for example, after 23 hours and 59 minutes) after receiving the previous connection information.

If the AFC update time has not come in step S16 (step S16: No), the processor 11 repeats the process of step S16 until the AFC update time comes. That is, the processor 11 continues the wireless communication on the UNII-6 to UNII-8 channels until the AFC update time comes.

If the AFC update time has come in step S16 (step S16: Yes), the processor 11 returns to step S11 to continue the wireless communication on the UNII-6 to UNII-8 channels and repeats the present processing.

On the other hand, if the position information cannot be acquired in step S12 (step S12: No), the processor 11 sets the communication channel of the wireless communication in the wireless LAN to UNII-5 and allows the wireless LAN router 10 to start the wireless communication on UNII-5 (step S17). Accordingly, a communication terminal (for example, the communication terminals 24 and 25) being connected with the wireless LAN router 10 follows this and starts the wireless communication on UNII-5.

Next, the processor 11 performs the acquisition processing of the position information of the wireless LAN router 10 by the GNSS unit 17 again (step S18). Next, the processor 11 determines whether the position information of the wireless LAN router 10 is acquired by the acquisition processing of the position information in step S18 (step S19).

If the position information can be acquired in step S19 (step S19: Yes), the processor 11 proceeds to step S13 and sequentially executes processes of steps S13 to S16 described above.

If the position information cannot be acquired in step S19 (step S19: No), the processor 11 transmits, to the communication terminal (for example, the communication terminals 24 and 25) being connected with the wireless LAN router 10, a position information request for requesting position information of the communication terminal (step S20).

Next, the processor 11 receives the position information from the communication terminal to which the position information request is transmitted in step S20 (step S21), and then proceeds to step S13 to sequentially execute the processes of steps S13 to S16 described above. When the processing proceeds from step S21 to step S13, the “position information” transmitted by the processor 11 to the AFC system 30 in step S13 is the position information of the communication terminals (for example, the communication terminals 24 and 25) being connected with the wireless LAN router 10.

In the above processing, in a case where there is no communication terminal being connected with the wireless LAN router 10, in a case where there is a communication terminal being connected with the wireless LAN router 10 but the communication terminal is not equipped with the GNSS unit, or in a case where the position information is not returned although the position information request is made to the communication terminal, the processor 11 repeats the acquisition processing of the position information by the GNSS unit and the transmission of the position information request to the communication terminal being connected with the wireless LAN router 10 while maintaining the communication channel in UNII-5, and proceeds to step S13 when the position information can be acquired.

In the above processing, step S18 and step S19 may be omitted, and the processing may proceed to step S20. When the wireless LAN router 10 is set to the UNII-6 to UNII-8 channels, before the communication channel is set to UNII-5 in step S17, the position information may be acquired from the communication terminal using the UNII-6 to UNII-8 channels, and then the communication channel may be set to UNII-5.

Operations of Wireless System 1 according to First Embodiment

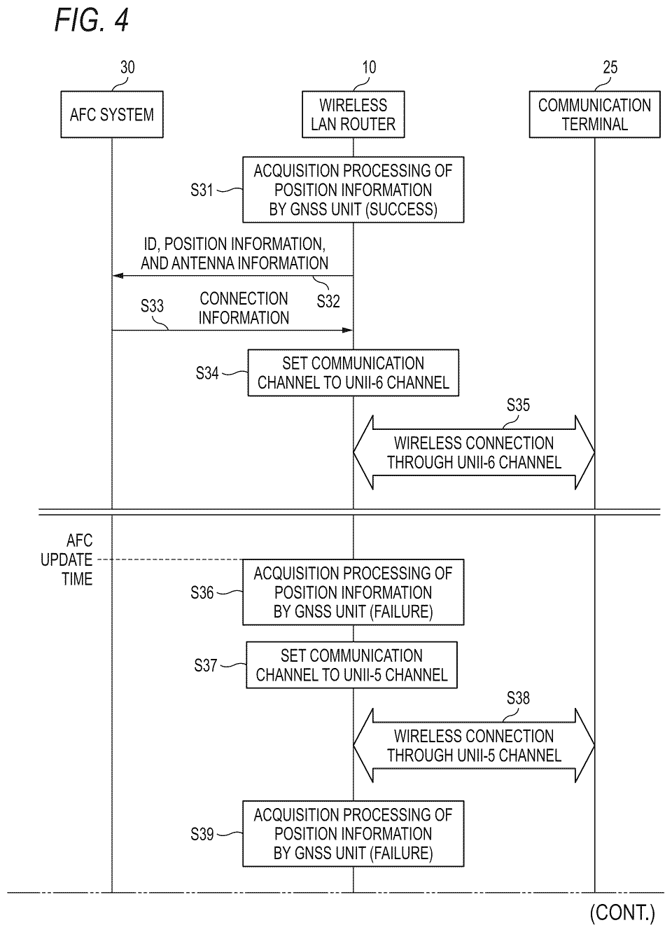

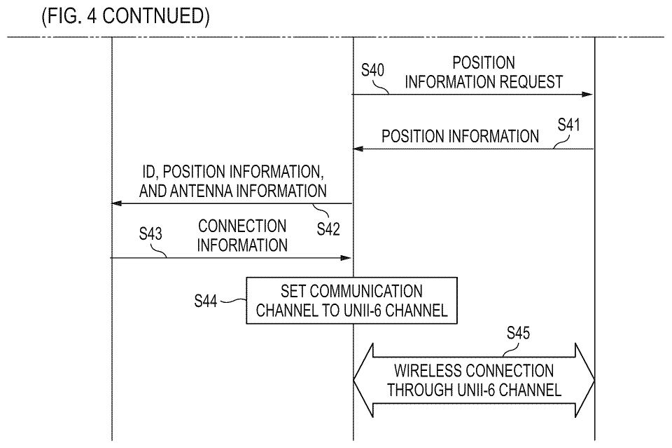

FIG. 4 is a sequence diagram showing operations of the AFC system 30, the wireless LAN router 10, and the communication terminal 25 in the wireless system 1 according to the first embodiment.

First, the wireless LAN router 10 performs acquisition processing of the position information of the wireless LAN router 10 by the GNSS unit 17, for example, when the wireless LAN router 10 is activated (step S31). For example, it is assumed that the position information can be acquired in the acquisition processing (success). The wireless LAN router 10 transmits, for example, the ID, position information, and antenna information of the wireless LAN router 10 to the AFC system 30 (step S32).

Next, when the AFC system 30 receives the ID, position information, antenna information, and the like from the wireless LAN router 10, the AFC system 30 transmits “connection information” that permits the use of the wireless communication on the UNII-6 to UNII-8 channels to the wireless LAN router 10 (step S33). The connection information indicating the permission for use includes, for example, a usage frequency of the wireless communication, the UNII-6 to UNII-8 channels that are permitted to be used, allocation of wireless output, and the like. Here, it is assumed that the use of the UNII-6 channel is instructed.

Next, the wireless LAN router 10 sets the communication channel of the wireless communication in the wireless LAN to UNII-6 based on the connection information received from the AFC system 30 (step S34). When the wireless LAN router 10 sets the communication channel to UNII-6, the wireless LAN router 10 and the communication terminal 25 are wirelessly connected through the UNII-6 channel (step S35).

Next, it is assumed that the AFC update time (for example, 23:59, which is the DHCP lease time) in the AFC system 30 has come. The wireless LAN router 10 performs acquisition processing of the position information of the wireless LAN router 10 by the GNSS unit 17 (step S36). For example, it is assumed that the position information cannot be acquired in the acquisition processing (failure). Specifically, it is assumed that the wireless LAN router 10 is installed indoors, the radio wave environment is not preferable, and the position information cannot be acquired based on the GNSS signal from the GNSS satellite 3. In this case, the wireless LAN router 10 sets the communication channel of the wireless communication in the wireless LAN to UNII-5 (step S37).

When the wireless LAN router 10 sets the communication channel to UNII-5, the wireless LAN router 10 and the communication terminal 25 are wirelessly connected through the UNII-5 channel (step S38).

Next, the wireless LAN router 10 performs the acquisition processing of the position information of the wireless LAN router 10 by the GNSS unit 17 again (step S39). For example, it is assumed that the position information cannot be acquired also in the acquisition processing (failure). In this case, the wireless LAN router 10 transmits a position information request for requesting the communication terminal 25 to notify the position information of the communication terminal 25 through the UNII-5 channel (step S40).

Next, upon receiving the position information request from the wireless LAN router 10, the communication terminal 25 transmits the position information of the communication terminal 25 acquired by the communication terminal 25 to the wireless LAN router 10 (step S41).

Next, the wireless LAN router 10 transmits, for example, the ID, position information, and antenna information of the wireless LAN router 10 to the AFC system 30 (step S42). At this time, the wireless LAN router 10 transmits the position information of the communication terminal 25 received from the communication terminal 25 in step S41 as the position information of the wireless LAN router 10 to the AFC system 30.

Next, the AFC system 30 transmits “connection information” that permits the use of the wireless communication on the UNII-6 to UNII-8 channels to the wireless LAN router 10 as in step S33 (step S43). Here, it is also assumed that the “connection information” includes information indicating the use of the UNII-6 channel.

Next, the wireless LAN router 10 sets the communication channel of the wireless communication in the wireless LAN to UNII-6 based on the connection information received from the AFC system 30 (step S44). When the wireless LAN router 10 sets the communication channel to UNII-6, the wireless LAN router 10 and the communication terminal 25 are wirelessly connected through the UNII-6 channel (step S45).

In the operation example, the case where the wireless LAN router 10 requests the position information from the communication terminal 25 is described, but the communication terminal to be requested is not limited to the communication terminal 25. For example, the wireless LAN router 10 may request the position information from a communication terminal with the highest radio wave intensity, a communication terminal with the shortest distance, or the like among the plurality of communication terminals (for example, the communication terminals 24 and 25) communicably connected to the wireless LAN router 10. Further, the wireless LAN router 10 may request the position information from the plurality of communication terminals, and in this case, for example, an average value of the position information calculated based on these pieces of position information may be used as the position information of the communication terminal.

As described above, according to the wireless LAN router 10 of the first embodiment, even in a situation where it is difficult to acquire the position information of the wireless LAN router 10 by the GNSS unit 17 mounted on the wireless LAN router 10, it is possible to temporarily set the communication channel of the wireless communication in the wireless LAN to UNII-5, receive the position information of the communication terminal 25 from the communication terminal 25 being connected with the wireless LAN router 10, and obtain the permission for use of the communication channels of UNII-6 to UNII-8 from the AFC system 30 using the position information. By setting a wireless communication channel to UNII-5, even when the permission for use of UNII-6 to UNII-8 with the AFC system 30 cannot be updated, it is possible to prevent communication disconnection in the wireless LAN. Therefore, even when it is difficult to acquire the GPS signal, it is possible to perform communication connection to the communicable communication channels (UNII-6 to UNII-8) while preventing communication disconnection in the wireless LAN.

Processing Performed by Processor 11 of Wireless LAN Router 10 according to Second Embodiment

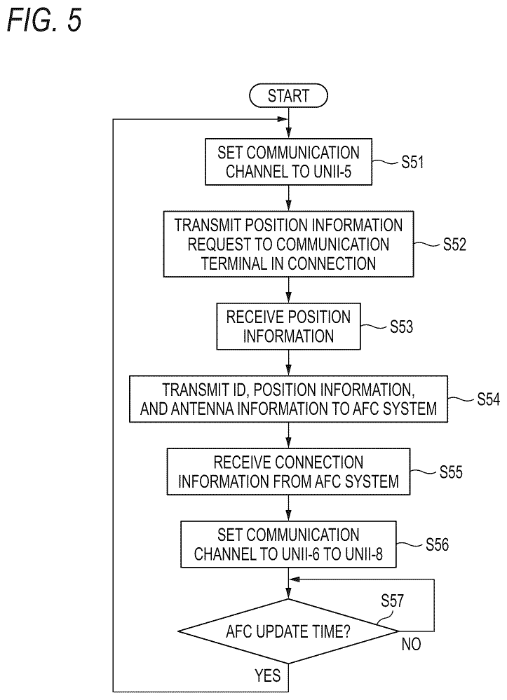

FIG. 5 is a flowchart showing processing performed by the processor 11 of the wireless LAN router 10 according to a second embodiment. In the processing of the first embodiment described in FIG. 3, the case where the wireless LAN router 10 includes the GNSS unit 17 has been described. On the other hand, in the second embodiment, processing will be described in a case where the wireless LAN router 10 does not include the GNSS unit 17 or a case where the wireless LAN router 10 includes the GNSS unit 17 but a failure occurs in the GNSS unit 17.

First, when the wireless LAN router 10 is activated, the processor 11 sets the communication channel of the wireless communication in the wireless LAN to UNII-5 and allows the wireless LAN router 10 to start the wireless communication on UNII-5 (step S51). Accordingly, a communication terminal (for example, the communication terminals 24 and 25) being connected with the wireless LAN router 10 follows this and starts the communication on UNII-5.

Next, the processor 11 transmits, to the communication terminal (for example, the communication terminals 24 and 25) being connected with the wireless LAN router 10, a position information request for requesting position information of the communication terminal (step S52). Next, the processor 11 receives the position information from the communication terminal to which the position information request is transmitted in step S52 (step S53).

Next, the processor 11 transmits, for example, the ID, position information, and antenna information of the wireless LAN router 10 to the AFC system 30 (step S54). The “position information” is obtained by regarding the position information of the communication terminal (for example, the communication terminals 24 and 25) received in step S53 as the position information of the wireless LAN router 10.

Next, the processor 11 receives, from the AFC system 30, “connection information” which is a reply of a permission for use of the UNII-6 to UNII-8 channels from the AFC system 30 in response to the transmission of the information in step S54 (step S55). Next, the processor 11 sets the communication channel of the wireless communication in the wireless LAN to UNII-6 to UNII-8 based on the connection information received from the AFC system 30 in step S55 (step S56).

Next, the processor 11 determines whether an AFC update time in the AFC system 30 has come (step S57). If the AFC update time has not come (step S57: No), the processor 11 repeats the process of step S57 until the AFC update time comes. If the AFC update time has come (step S57: Yes), the processor 11 returns to step S51 to continue the wireless communication on the UNII-6 to UNII-8 channels and repeats the present processing.

The processing of the processor 11 in the case where there is no communication terminal being connected with the wireless LAN router 10, the case where there is the communication terminal being connected with the wireless LAN router 10 but the communication terminal is not equipped with the GNSS unit, and the case where the position information is not returned although the position information request is made to the communication terminal is the same as the processing of the processor 11 in FIG. 3.

Operations of Wireless System 1 according to Second Embodiment

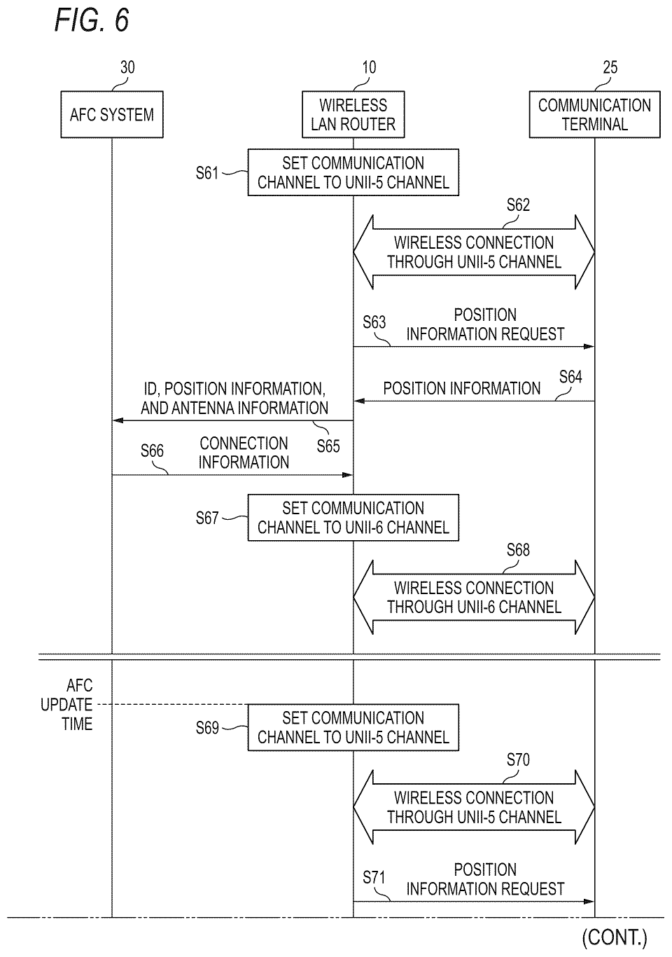

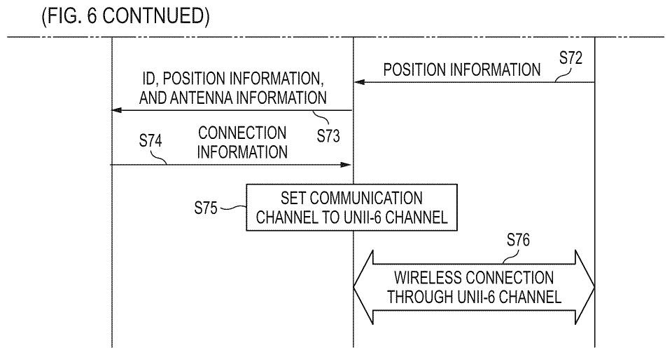

FIG. 6 is a sequence diagram showing operations of the AFC system 30, the wireless LAN router 10, and the communication terminal 25 in the wireless system 1 according to the second embodiment. Operations of the second embodiment are operations when the processor 11 of the wireless LAN router 10 executes the processing of the second embodiment described in FIG. 5.

First, the wireless LAN router 10 sets the communication channel of the wireless communication in the wireless LAN to UNII-5, for example, when the wireless LAN router 10 is activated (step S61). When the wireless LAN router 10 sets the communication channel to UNII-5, the wireless LAN router 10 and the communication terminal 25 are wirelessly connected through the UNII-5 channel (step S62). The wireless LAN router 10 transmits a position information request for requesting the communication terminal 25 to notify the position information of the communication terminal 25 through the UNII-5 channel (step S63.

Next, upon receiving the position information request from the wireless LAN router 10, the communication terminal 25 transmits the position information of the communication terminal 25 acquired by the communication terminal 25 to the wireless LAN router 10 (step S64).

Next, the wireless LAN router 10 transmits, for example, the ID, position information, and antenna information of the wireless LAN router 10 to the AFC system 30 (step S65). The wireless LAN router 10 transmits the position information of the communication terminal 25 received from the communication terminal 25 in step S64 as the position information of the wireless LAN router 10 to the AFC system 30.

Next, when the AFC system 30 receives the ID, position information, antenna information, and the like from the wireless LAN router 10, the AFC system 30 transmits “connection information” that permits the use of the wireless communication on the UNII-6 to UNII-8 channels to the wireless LAN router 10 (step S66). Here, it is assumed that the use of the UNII-6 channel is instructed.

Next, the wireless LAN router 10 sets the communication channel of the wireless communication in the wireless LAN to UNII-6 based on the connection information received from the AFC system 30 (step S67). When the wireless LAN router 10 sets the communication channel to UNII-6, the wireless LAN router 10 and the communication terminal 25 are wirelessly connected through the UNII-6 channel (step S68).

Next, when the AFC update time in the AFC system 30 comes, the wireless LAN router 10 sets the communication channel of the wireless communication in the wireless LAN to UNII-5 (step S69).

The processes from step S70 to step S76 are the same as the processes from step S62 to step S68, and thus description thereof will be omitted. In the operations of the second embodiment, the case has been described in which the wireless LAN router 10 acquires the position information from the same communication terminal 25 in steps S63 and S71, but the present disclosure is not limited thereto. The wireless LAN router 10 may acquire the position information from another communication terminal (for example, the communication terminal 24). For example, the wireless LAN router 10 may acquire the position information from a communication terminal with the highest radio wave intensity, a communication terminal with the shortest distance, or the like among the plurality of communication terminals (for example, the communication terminals 24 and 25) communicably connected to the wireless LAN router 10.

As described above, according to the wireless LAN router 10 of the second embodiment, even in a situation where the wireless LAN router 10 itself cannot acquire the position information of the wireless LAN router 10 because the wireless LAN router 10 is not equipped with the GNSS unit 17 or the mounted GNSS unit 17 is malfunctioning, it is possible to temporarily set the communication channel of the wireless communication in the wireless LAN to UNII-5, receive the position information of the communication terminal 25 from the communication terminal 25 being connected with the wireless LAN router 10, and obtain the permission for use of the communication channels of UNII-6 to UNII-8 from the

AFC system 30 using the position information. Accordingly, even when it is difficult to acquire the GPS signal, it is possible to perform communication connection to the communicable communication channels (UNII-6 to UNII-8) while preventing communication disconnection in the wireless LAN.

### Modification of Processing Performed by Processor 11 of Wireless LAN Router 10

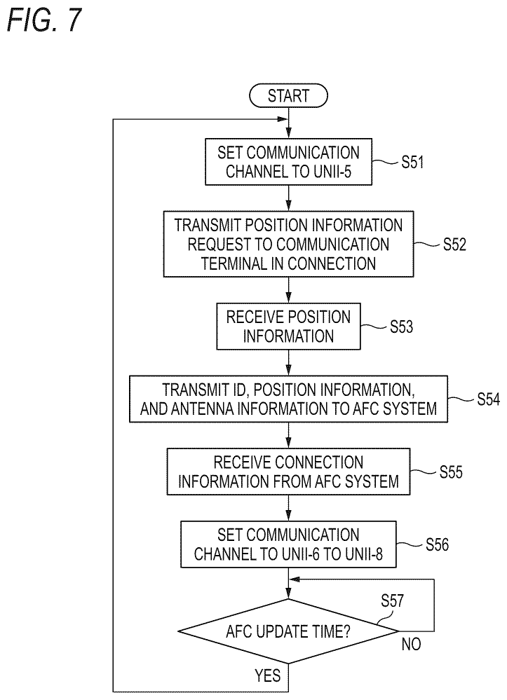

FIG. 7 is a flowchart showing a modification of the processing performed by the processor 11 according to the second embodiment described in FIG. 5. In the processing of the second embodiment shown in FIG. 5, the embodiment has been described in which if the AFC update time has come in step S57 (step S57: Yes), the processor 11 returns to step S51 to continue the wireless communication on the UNII-6 to UNII-8 channels and repeats the present processing. On the other hand, in the present modification, when the AFC update time has come, the processor 11 returns to step S52 and repeats the present processing.

That is, when the AFC update time (for example, 23:59, which is the DHCP lease time) has come, the processor 11 returns to step S52, and transmits, to the communication terminal (for example, the communication terminals 24 and 25) being connected with the wireless LAN router 10, a position information request for requesting position information of the communication terminal while keeping the communication channel of the wireless communication in the wireless LAN in the state of UNII-6 to UNII-8 set in step S56. Until an allocation period of the “connection information” received from the AFC system 30 ends (for example, until 24:00), the next “connection information” is received from the AFC system 30 to perform the processing of setting the communication channel of the wireless communication to UNII-6 to UNII-8 (the processes from step S53 to step S56). The processes from step S51 to step S57 in the present modification are the same as the processes from step S51 to step S57 in the processing of the second embodiment in FIG. 5, and thus further detailed description thereof will be omitted.

For example, in a case where the processor 11 returns from step S57 to step S52 and cannot acquire the “position information” from the communication terminal in the state of the communication channels of UNII-6 to UNII-8, the processor 11 returns to step S51, sets the communication channel of the wireless communication in the wireless LAN to UNII-5, and then repeats each process. Similarly, in a case where the processor 11 returns from step S57 to step S52 and cannot acquire the “connection information” from the AFC system 30 in the state of the communication channels of UNII-6 to UNII-8, the processor 11 returns to step S51, sets the communication channel of the wireless communication in the wireless LAN to UNII-5, and then repeats each process.

### Modification of Operation of Wireless System 1

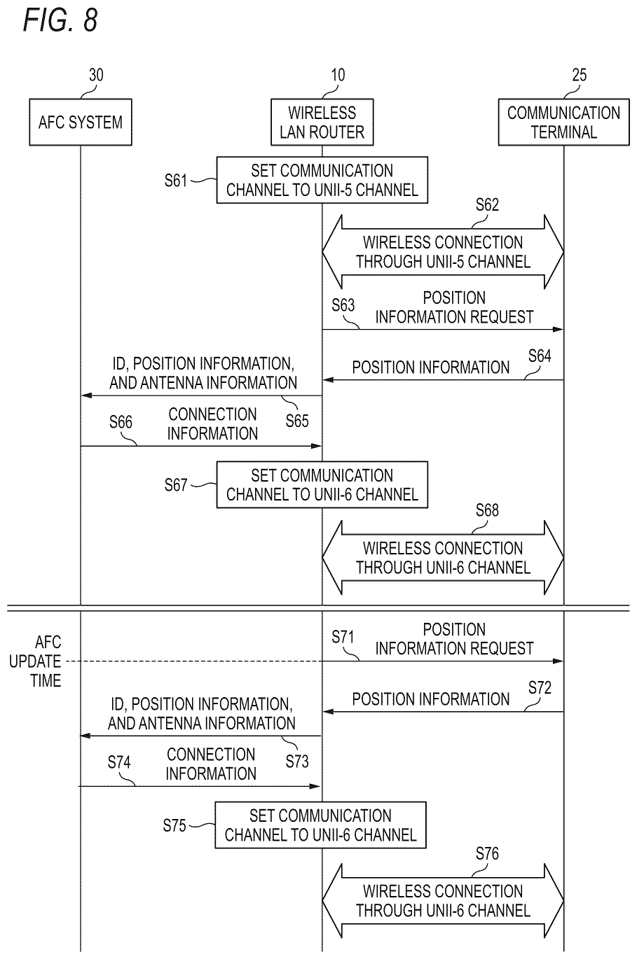

FIG. 8 is a sequence diagram showing a modification of the operations of the AFC system 30, the wireless LAN router 10, and the communication terminal 25 in the wireless system 1 according to the second embodiment described in FIG. 6. In the present modification, the processor 11 of the wireless LAN router 10 executes the modification of the processing of the second embodiment described in FIG. 7.

The operations of the AFC system 30, the wireless LAN router 10, and the communication terminal 25 in step S61 to step S68 of the present modification are the same as the operations of the AFC system 30, the wireless LAN router 10, and the communication terminal 25 in step S61 to step S68 in the operations of the second embodiment in FIG. 6, and thus the description thereof will be omitted.

Next, when the AFC update time in the AFC system 30 comes, the wireless LAN router 10 transmits, to the communication terminal 25 being connected with the wireless LAN router 10, a position information request for requesting position information of the communication terminal 25 while keeping the communication channel of the wireless communication in the wireless LAN in the state of UNII-6 to UNII-8 (step S71). In the present modification, when the AFC update time of the AFC system 30 has come, the processor 11 does not set the communication channel of the wireless communication in the wireless LAN to UNII-5.

The operations of the AFC system 30, the wireless LAN router 10, and the communication terminal 25 in step S72 to step S76 are the same as the operations of the AFC system 30, the wireless LAN router 10, and the communication terminal 25 in step S72 to step S76 in the operations of the second embodiment in FIG. 6, and thus the description thereof will be omitted.

As described above, according to the wireless LAN router 10 of the modification, in a case where the wireless LAN router 10 itself cannot acquire the position information of the wireless LAN router 10 because the wireless LAN router 10 is not equipped with the GNSS unit 17 or the mounted GNSS unit 17 is malfunctioning, it is possible to receive the position information of the communication terminal 25 from the communication terminal 25 being connected with the wireless LAN router 10 in the communication state of the UNII-6 to UNII-8 channels and obtain the permission for use of the communication channels of the UNII-6 to UNII-8 from the AFC system 30 using the position information, without performing the temporary setting to the UNII-5 channel except when the wireless LAN router 10 is activated. Accordingly, even when it is difficult to acquire the GPS signal, it is possible to perform communication connection to the communicable communication channels (UNII-6 to UNII-8) while preventing communication disconnection in the wireless LAN.

### Control Program

A control method of the wireless device described in the above embodiments can be implemented by executing a control program prepared in advance on a computer. The control program is stored in a computer-readable storage medium and is executed by being read from the storage medium. The control program may be provided by being stored in a non-transitory storage medium such as a flash memory, or may be provided via a network such as the Internet. The computer that executes the control program may be included in a wireless device, may be included in an electronic device such as a smartphone, a tablet terminal, or a personal computer that can communicate with the wireless device, or may be included in a server device that can communicate with a wireless device and the electronic device.

As described above, the following matters are disclosed in the present specification.

A disclosed wireless device includes: a wireless communication interface configured to perform wireless communication on a first communication channel which is available under a condition that the wireless device transmits position information to a server, and wireless communication on a second communication channel different from the first communication channel; and a control circuit configured to perform processing under a condition that the wireless device is not able to acquire position information of the wireless device. The processing includes: allowing the wireless communication interface to start the wireless communication on the second communication channel with a communication terminal; receiving position information of the communication terminal from the communication terminal; and transmitting the position information of the communication terminal that is received to the server to make available the wireless communication on the first communication channel.

The wireless device may further include: a position acquisition circuit configured to acquire the position information of the wireless device. The control circuit is further configured to perform the processing under a condition that the position acquisition circuit is not able to acquire the position information of the wireless device.

The control circuit may further be configured to perform the processing under a condition that the wireless device does not include a position acquisition circuit configured to acquire the position information of the wireless device and the wireless device is not able to acquire the position information of the wireless device.

The processing may further include: retrying to acquire the position information of the wireless device after allowing the wireless communication interface to start the wireless communication on the second communication channel with a communication terminal; and receiving the position information of the communication terminal from the communication terminal to transmit to the server under a condition that the wireless device is not able to acquire the position information of the wireless device in the retrying.

The processing may further include: allowing the wireless communication interface to start the wireless communication on the second communication channel with plural communication terminals; selecting one of the plural communication terminals based on a respective radio wave intensity between the wireless device and the plural communication terminals; and receiving position information of the one of the plural communication terminals to transmit to the server.

A radio wave intensity between the wireless device and the one of the plural communication terminals that is selected may be higher than a respective radio wave intensity between the wireless device and other of the plural communication terminals.

The processing may further include: allowing the wireless communication interface to start the wireless communication on the second communication channel with plural communication terminals; selecting one of the plural communication terminals based on a respective distance between the wireless device and the plural communication terminals; and receiving position information of the one of the plural communication terminals to transmit to the server.

A distance between the wireless device and the one of the plural communication terminals that is selected may be shorter than a respective distance between the wireless device and other of the plural communication terminals.

The processing may further include: allowing the wireless communication interface to start the wireless communication on the second communication channel with plural communication terminals; receiving position information of the plural communication terminals; selecting, from the position information that is received, position information of one of the plural communication terminals based on a respective time at which the position information of the plural communication terminals is received; and transmitting to the server the position information of the one of the plural communication terminals that is selected.

The position information of the one of the plural communication terminals that is selected may be received at a later time than a respective time at which the position information of other of the plural communication terminals is received.

The processing may further include: allowing the wireless communication interface to start the wireless communication on the second communication channel with plural communication terminals; receiving position information of the plural communication terminals; calculating certain position information based on the position information of the plural communication terminals that is received; and transmitting to the server the certain position information that is calculated.

The certain position information that is calculated may be an average value or a median value of the position information of the plural communication terminals.

The processing may further include: calculating certain position information based on the position information of the communication terminal that is received and a positional relationship between the communication terminal and the wireless device; and transmitting to the server the certain position information that is calculated.

The certain position information may be calculated by correcting the position information of the communication terminal with the positional relationship between the communication terminal and the wireless device.

The processing may further include: receiving the position information of the communication terminal from the communication terminal through the wireless communication on the second communication channel; and transmitting the position information that is received to the server.

The first communication channel may be a communication channel of Unlicensed National Information Infrastructure (UNII)-6 to UNII-8, and the second communication channel is a communication channel of UNII-5.

A control method for a wireless device has a wireless communication interface, to be performed by a processor of the wireless device. The method includes: controlling the wireless communication interface to perform wireless communication on a first communication channel which is available under a condition that the wireless device transmits position information to a server, and wireless communication on a second communication channel different from the first communication channel; and under a condition that the wireless device is not able to acquire position information of the wireless device, allowing the wireless communication interface to start the wireless communication on the second communication channel with a communication terminal; receiving, from the communication terminal, position information of the communication terminal; and transmitting the position information of the communication terminal that is received to the server to make available the wireless communication on the first communication channel.

A non-transitory computer-readable storage medium stores a control program for causing a computer of a wireless device having a wireless communication interface to execute a process. The process includes: controlling the wireless communication interface to perform wireless communication on a first communication channel which is available under a condition that the wireless device transmits position information to a server, and wireless communication on a second communication channel different from the first communication channel, and under a condition that the wireless device is not able to acquire position information of the wireless device, allowing the wireless communication interface to start the wireless communication on the second communication channel with a communication terminal; receiving, from the communication terminal, position information of the communication terminal; and transmitting the position information of the communication terminal that is received to the server to make available the wireless communication on the first communication channel.

1. A wireless device comprises:
a wireless communication interface configured to perform wireless communication on a first communication channel which is available under a condition that the wireless device transmits position information to a server, and wireless communication on a second communication channel different from the first communication channel; and
a control circuit configured to perform processing under a condition that the wireless device is not able to acquire position information of the wireless device, wherein the processing includes:
allowing the wireless communication interface to start the wireless communication on the second communication channel with a communication terminal;
receiving position information of the communication terminal from the communication terminal; and
transmitting the position information of the communication terminal that is received to the server to make available the wireless communication on the first communication channel.

2. The wireless device according to claim 1, further comprising:
a position acquisition circuit configured to acquire the position information of the wireless device, wherein
the control circuit is further configured to perform the processing under a condition that the position acquisition circuit is not able to acquire the position information of the wireless device.

3. The wireless device according to claim 1, wherein
the control circuit is further configured to perform the processing under a condition that the wireless device does not include a position acquisition circuit configured to acquire the position information of the wireless device and the wireless device is not able to acquire the position information of the wireless device.

4. The wireless device according to claim 1, wherein
the processing further includes:
retrying to acquire the position information of the wireless device after allowing the wireless communication interface to start the wireless communication on the second communication channel with a communication terminal; and
receiving the position information of the communication terminal from the communication terminal to transmit to the server under a condition that the wireless device is not able to acquire the position information of the wireless device in the retrying.

5. The wireless device according to claim 1, wherein
the processing further includes:
allowing the wireless communication interface to start the wireless communication on the second communication channel with plural communication terminals;
selecting one of the plural communication terminals based on a respective radio wave intensity between the wireless device and the plural communication terminals; and
receiving position information of the one of the plural communication terminals to transmit to the server.

6. The wireless device according to claim 5, wherein
a radio wave intensity between the wireless device and the one of the plural communication terminals that is selected is higher than a respective radio wave intensity between the wireless device and other of the plural communication terminals.

7. The wireless device according to claim 1, wherein
the processing further includes:
allowing the wireless communication interface to start the wireless communication on the second communication channel with plural communication terminals;
selecting one of the plural communication terminals based on a respective distance between the wireless device and the plural communication terminals; and
receiving position information of the one of the plural communication terminals to transmit to the server.

8. The wireless device according to claim 7, wherein
a distance between the wireless device and the one of the plural communication terminals that is selected is shorter than a respective distance between the wireless device and other of the plural communication terminals.

9. The wireless device according to claim 1, wherein
the processing further includes:
allowing the wireless communication interface to start the wireless communication on the second communication channel with plural communication terminals;
receiving position information of the plural communication terminals;
selecting, from the position information that is received, position information of one of the plural communication terminals based on a respective time at which the position information of the plural communication terminals is received; and
transmitting to the server the position information of the one of the plural communication terminals that is selected.

10. The wireless device according to claim 9, wherein
the position information of the one of the plural communication terminals that is selected is received at a later time than a respective time at which the position information of other of the plural communication terminals is received.

11. The wireless device according to claim 1, wherein
the processing further includes:
allowing the wireless communication interface to start the wireless communication on the second communication channel with plural communication terminals;
receiving position information of the plural communication terminals;
calculating certain position information based on the position information of the plural communication terminals that is received; and
transmitting to the server the certain position information that is calculated.

12. The wireless device according to claim 11, wherein
the certain position information that is calculated is an average value or a median value of the position information of the plural communication terminals.

13. The wireless device according to claim 1, wherein
the processing further includes:
calculating certain position information based on the position information of the communication terminal that is received and a positional relationship between the communication terminal and the wireless device; and
transmitting to the server the certain position information that is calculated.

14. The wireless device according to claim 13, wherein
the certain position information is calculated by correcting the position information of the communication terminal with the positional relationship between the communication terminal and the wireless device.

15. The wireless device according to claim 1, wherein the processing further includes:
receiving the position information of the communication terminal from the communication terminal through the wireless communication on the second communication channel; and
transmitting the position information that is received to the server.

16. The wireless device according to claim 1, wherein
the first communication channel is a communication channel of Unlicensed National Information Infrastructure (UNII)-6 to UNII-8, and the second communication channel is a communication channel of UNII-5.

17. A control method for a wireless device having a wireless communication interface, to be performed by a processor of the wireless device, the control method comprising:
controlling the wireless communication interface to perform wireless communication on a first communication channel which is available under a condition that the wireless device transmits position information to a server, and wireless communication on a second communication channel different from the first communication channel; and
under a condition that the wireless device is not able to acquire position information of the wireless device,
allowing the wireless communication interface to start the wireless communication on the second communication channel with a communication terminal;
receiving, from the communication terminal, position information of the communication terminal; and
transmitting the position information of the communication terminal that is received to the server to make available the wireless communication on the first communication channel.

18. A non-transitory computer-readable storage medium that stores a control program for causing a computer of a wireless device having a wireless communication interface to execute a process, the process comprising:
controlling the wireless communication interface to perform wireless communication on a first communication channel which is available under a condition that the wireless device transmits position information to a server, and wireless communication on a second communication channel different from the first communication channel, and
under a condition that the wireless device is not able to acquire position information of the wireless device,
allowing the wireless communication interface to start the wireless communication on the second communication channel with a communication terminal;
receiving, from the communication terminal, position information of the communication terminal; and
transmitting the position information of the communication terminal that is received to the server to make available the wireless communication on the first communication channel.
